(19) United States
(12) Patent Application Publication
(10) Pub. No.: US 2008/0290310 A1
(43) Pub. Date: Nov. 27, 2008

(54) Valve Device With Safety Mechanism

(76) Inventor: Wilfried Unrath, Gerstetten (DE)

Correspondence Address: CARLSON, GASKEY & OLDS, P.C., 400 WEST MAPLE ROAD, SUITE 350, BIRMINGHAM, MI, 48009, US

(21) Appl. No.: 11/916,584

(22) PCT Filed: Jun. 6, 2006
(86) PCT No.: PCT/EP2006/005371

§ 371 Date: Jul. 1, 2008

(30) Foreign Application Priority Data
Jun. 6, 2005 (DE) 20 2005 008 794.7

(51) Int. Cl. F16K 1/00

(52) U.S. Cl. 251/324

(57) ABSTRACT

A valve device (10), in particular for use in fire fighting, comprises a valve and a safety mechanism by which the valve can be closed. The valve is a pilot-controlled piston valve.

This invention relates to a valve device, in particular for use in fire fighting, comprising a valve and a safety mechanism by which the valve can be closed.

For extinguishing fire, generally large amounts of water or fire-extinguishing agent must be provided, which are under high pressure. Due to the high pressure, a certain risk potential exists for people in the vicinity of fire fighting equipment, supplying hose lines or distributors. It can happen, for instance, that a portable water gun knocked over by mistake or toppled over as a result of pressure fluctuations is not switched off in time before causing damage.

From WO 01/64292 A1, a generic valve device for a portable water gun is known. Various acceleration-sensitive safety mechanisms including complex actuators are proposed, by which the valve device can automatically be blocked in case the water gun falls down. Blocking the valve is effected either by shifting a pipe fitting onto a plug or by a shutting flap.

It is the object of the invention to provide an inexpensive valve device with a safety mechanism, which can be used for fire extinguishing means and allows reliable blocking with simple means.

This object is solved by a valve device with the features of claim 1. The invention is based on the finding that a pilot-controlled valve, which can be operated with a low switching force, is optimally suited for coupling to an acceleration-sensitive safety mechanism. A complex actuator means is not necessary. The safety mechanism must merely activate the pilot control of the piston valve, i.e. no additional measures are necessary for providing large biasing forces or the like. The valve device of the invention opens up universal application possibilities and can, for instance, also be applied in fire-fighting distributors.

Advantageous and expedient aspects of the valve device of the invention can be taken from the sub-claims.

The invention will subsequently be described with reference to an embodiment illustrated in the attached drawings, in which:

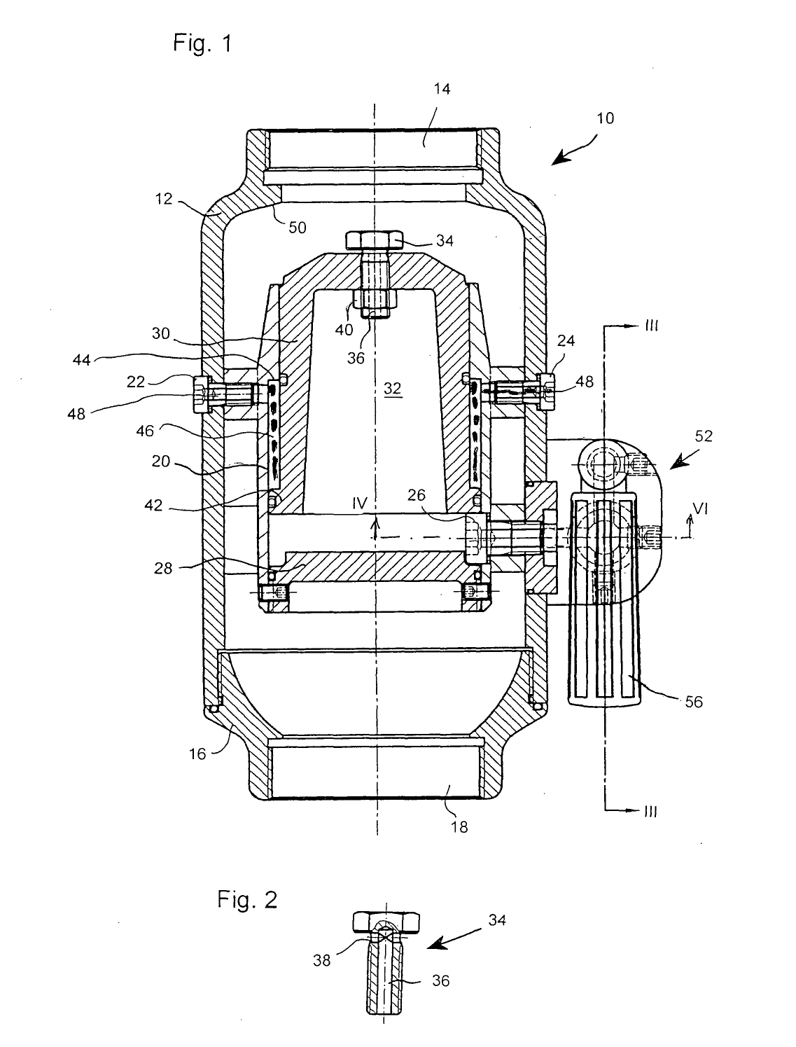

FIG. 1 shows a sectional top view of a valve device according to the invention in a first condition;

FIG. 2 shows a partly sectional view of the adjusting screw;

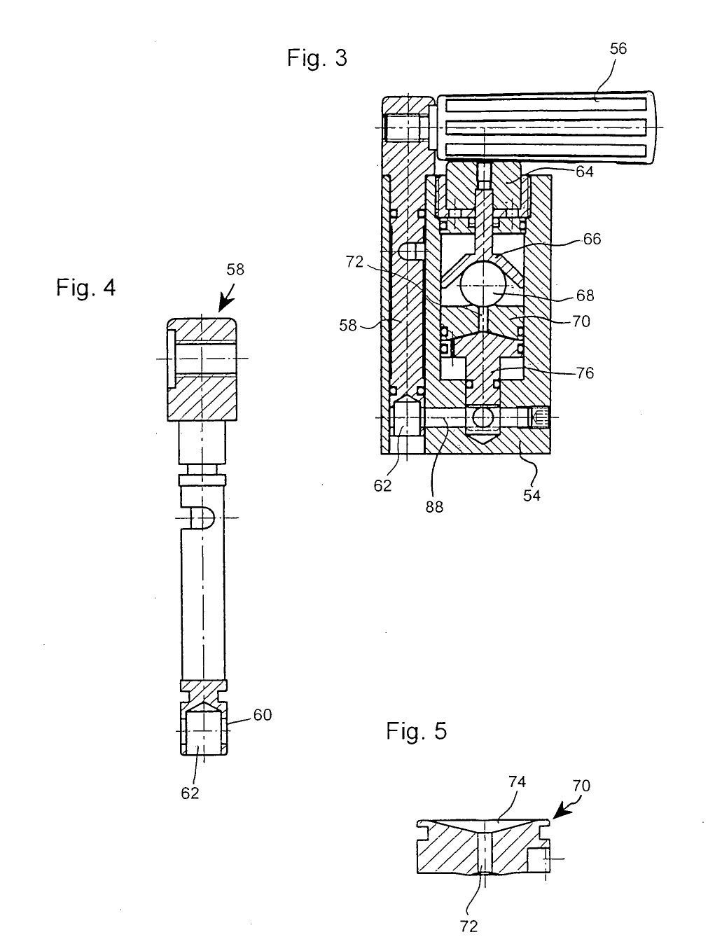

FIG. 3 shows a sectional view along line III-III of FIG. 1;

FIG. 4 shows a partly sectional view of the switch rod;

FIG. 5 shows a sectional view of the intermediate piece;

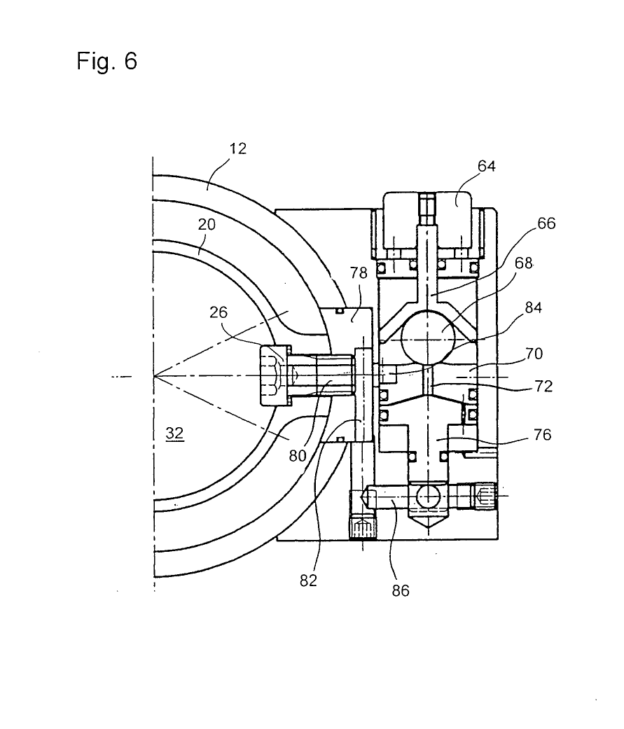

FIG. 6 shows a sectional view along line VI-VI of FIG. 1 without the switch lever;

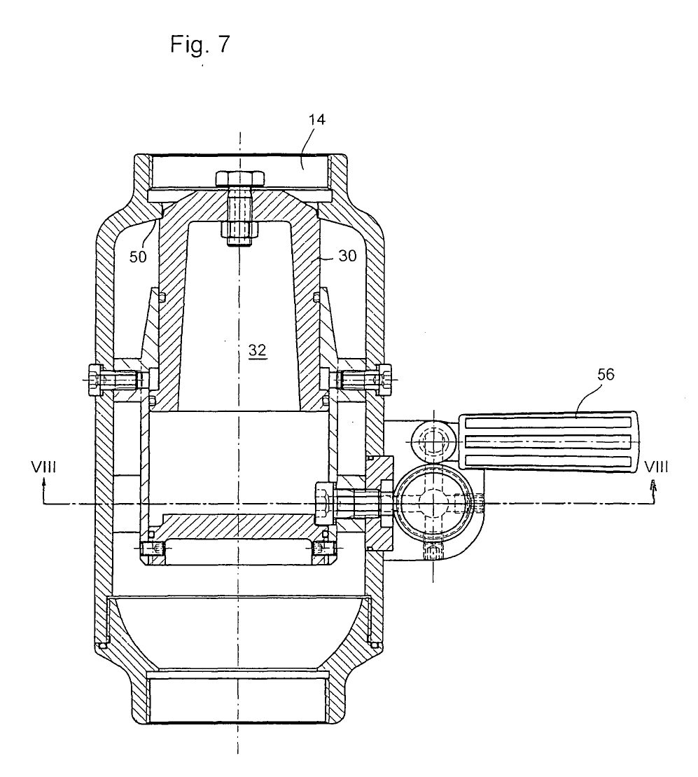

FIG. 7 shows the valve device of FIG. 1 in a second condition;

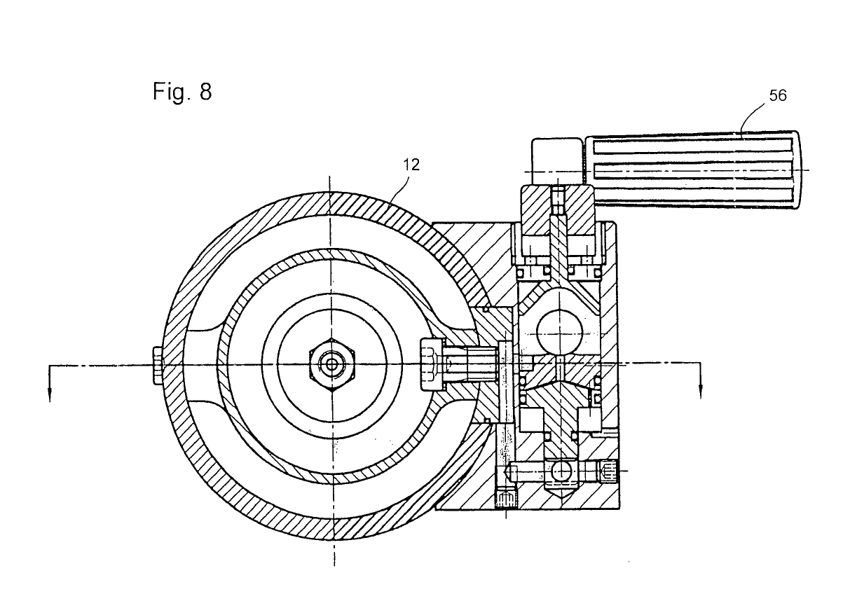

FIG. 8 shows a sectional view along line VIII-VIII of FIG. 7;

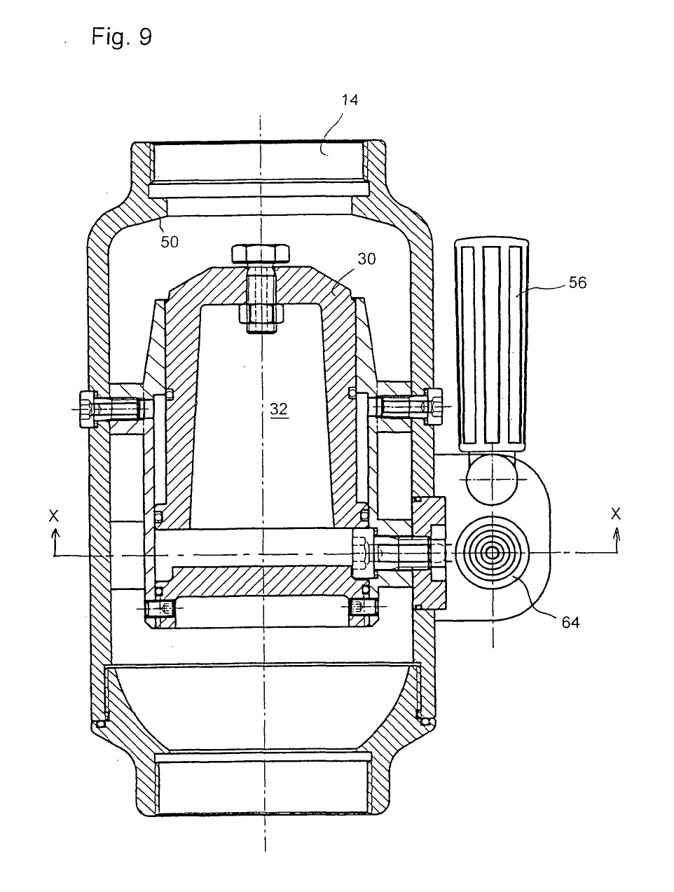

FIG. 9 shows the valve device of FIG. 1 in a third condition; and

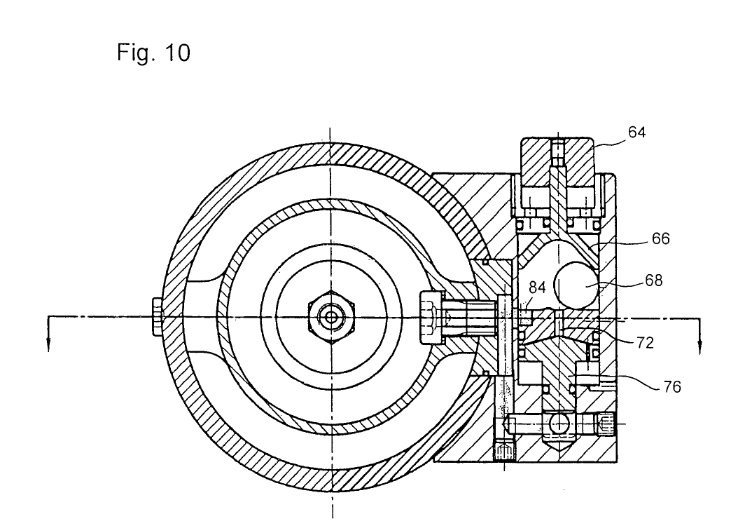

FIG. 10 shows a sectional view along linie X-X of FIG. 9 without the switch lever.

The valve device 10 shown in FIG. 1 comprises a piston valve with an elongated valve housing 12, on which a valve inlet 14 is formed on a first end side. On the opposite second end side, a sleeve nipple 16 is inserted, which forms a valve outlet 18. In the valve housing 12, a piston guide 20 is mounted with three fastening screws 22, 24, 26. The piston guide 20 is closed by a lid 28 on the side facing the outlet 18. In the piston guide 20, a piston 30 is movably mounted.

The piston 30 has a U-shaped cross-section, the two legs laterally defining a pressure space 32. On the end face of the piston 30 facing the inlet 14, an adjusting screw 34 with an axial bore 36 and radial bores 38 is inserted, which is illustrated in greater detail in FIG. 2. The effective cross-section, through which the water can enter the pressure space 32, can very finely be adjusted via a lock nut 40. Between a collar 42 of the piston 30 and a step 44 in the piston guide 20, an annular space 46 is formed, which is maintained at ambient pressure by bores 48 in the two fastening screws 22 and 24, which lead to the outside.

The piston 30 can be moved between the first position shown in FIG. 1 and the second position shown in FIG. 7. In the first position, the water can flow past the piston 30 and the piston guide 20 to the outlet 18, i.e. the valve is opened. In the second position, in which the piston 30 is urged against a valve seat 50 formed at the inlet 14, the valve is closed.

The valve device 10 furthermore comprises an operating means 52, by which the piston valve can be opened and closed. In the operating means 52 a safety mechanism is integrated, which in the case of a shock ensures that the piston valve blocks automatically. The operating means 52, whose components are shown in FIG. 3, includes a housing part 54, a switch lever 56, a switch rod 58 connected with the switch lever 56 (shown in detail in FIG. 4), which includes a radial through bore 60 and an axial bore 62 connected therewith, an axially movable pusher 64, a centering body 66 connected with the pusher 64, a steel ball 68, an intermediate piece 70 firmly connected with the housing part 54 (shown in detail in FIG. 5), which includes a bore 72 opening into a valve seat 74 for the ball 68, and a control piston 76.

The connection of the operating means 52 to the valve housing 12 is shown in FIG. 6. The fastening screw 26 fixes the piston guide 20 to a segment 78 glued into the valve housing 12. The fastening screw 26 has a central bore 80, which connects the pressure space 32 with a recess 82 of the segment 78. On the side facing the segment 78, the intermediate piece 70 likewise has a recess 84. Thus, the pressure space 32 is in flow connection both with the space surrounding the ball 68 and with the passages 86 and 88 crossing each other under the control piston.

The handling and operation of the valve device in accordance with the invention will be described below. In the first position of the switch lever 56 as shown in FIGS. 1 and 3, the piston valve is opened and the safety mechanism is shut off. The switch lever 56 holds the pusher 64 in a lower position, so that the centering body 66 centers the ball 68 on the valve seat 74. As in this condition the bore 72 of the intermediate piece 70 is closed by the ball 68, there is no pressure acting from the top onto the control piston 76. Rather, the water flowing through the first passage 86 urges the control piston 70 in upward direction and thus can flow into the second passage 88. In the first position of the switch lever 56, the switch rod 58 takes a position in which the water can flow from the second passage 88 through the radial bore 60 into the axial bore 62, from which it finally flows to the outside. Thus, it is ensured that no pressure is built up in the pressure space 32 despite the water flowing in through the adjusting screw 34. The piston 30 therefore remains in the position shown in FIG. 1. The quantity of water discharged from the axial bore 62 is so small that this causes no significant disturbance.

For closing the piston valve, the switch lever 56 is rotated by 90° C. into the second position shown in FIGS. 7 and 8. The switch rod 58 thereby takes a position in which the entrance from the second passage 88 into the axial bore 62 is blocked. Since the water thus cannot flow to the outside, a pressure is built up in the pressure space 32, which finally leads to the piston 30 being urged against the valve seat 50 and blocking the inlet 14.

In the third position of the switch lever 56 as shown in FIG. 9, the piston valve is opened and the safety mechanism is activated. Like in the first position, the switch rod 58 permits a discharge of water from the second passage 88, so that the piston 30 clears the valve seat 50. In contrast to the first position of the switch lever 56 (like also in the second position), however, the pusher 64 is not depressed; rather, the water entering through the recess 84 pushes the centering body 66 along with the pusher 64 in upward direction. Thus, the ball 68 is not held by the centering body 66 in this condition. If the ball 68 now experiences a certain acceleration as a result of a shock of the valve device 10, it moves away from the valve seat 74. This situation is illustrated in FIG. 10. Advantageously, clearing the bore 72 is effected substantially independent of the direction of the acceleration. The water entering the bore 72 applies a pressure onto the control piston 76, so that the same moves downwards and blocks the flow connection to the switch rod 58. Thereupon, a pressure is built up in the pressure space 32, as described already, and the piston 30 blocks the inlet 14.

The operating means 52 with the integrated safety mechanism thus constitutes a pilot control for the piston valve, whose closing speed can be adjusted very delicately via the adjusting screw 34.

The switch rod 56 and the pusher 64 are designed such that a foot operation also is possible in principle.

The ball 68 serving as sensor element also can be made of a material other than steel, e.g. of a PA, POM or PUR plastic material.

1. A valve device for use in fire fighting comprising;
a pilot-controlled piston valve; and
a safety mechanism that can close the pilot-controlled piston valve wherein the safety mechanism is acceleration-sensitive and provides for automatic blocking of the pilot-controlled piston valve in response to a shock.

2. The valve device according to claim 1, wherein the safety mechanism is integrated in an operating mechanism for operating the pilot-controlled piston valve.

3. The valve device according to claim 2, wherein the safety mechanism can be activated and deactivated by a pusher.

4. The valve device according to claim 3, wherein the operating mechanism with the safety mechanism includes a housing part, a switch lever, a switch rod connected with the switch lever an axially movable pusher, a centering body connected with the pusher, a ball (68), an intermediate piece firmly connected with the housing part, and a control piston, and wherein the switch rod includes a radial through bore and an axial bore connected therewith, and wherein the intermediate piece includes a bore opening into a valve seat for the ball.

5. The valve device according to claim 4, wherein when the pilot-controlled piston valve is opened and the safety mechanism is activated, the ball is not held by the centering body, and in response to an acceleration caused by a shock of the valve device, the ball moves away from the valve seat and clears the bore.

6. The valve device according to claim 5, wherein clearing the bore is effected substantially independent of a direction of the acceleration.

7. The device according to claim 2, wherein the operating mechanism includes a switch lever that is movable between a first position in which the pilot-controlled piston valve is opened, a second position in which the pilot-controlled piston valve is closed, and a third position in which the pilot-controlled piston valve is opened and the safety mechanism is activated.
